(19) United States
(12) Patent Application Publication
(10) Pub. No.: US 2022/0215468 A1
(43) Pub. Date: Jul. 7, 2022

(54) Computer Implemented Lending Management System and Method

(71) Applicant: Just Lend Limited, London (GB)

(72) Inventors: Craig Smith, London (GB); Sefton Monk, London (GB); Matthew Thornhill, Buxton (GB)

(21) Appl. No.: 17/569,004

(22) Filed: Jan. 5, 2022

(30) Foreign Application Priority Data
Jan. 6, 2021 (GB) 2100153.2

(51) Int. Cl. G06Q 40/02; G06Q 20/36; H04L 67/104

(52) U.S. Cl. CPC G06Q 40/025; H04L 67/104; G06Q 20/36

(57) ABSTRACT

A computer implemented lending management system and method are disclosed. A first user interface receives inputs on parameters for a loan being sought, a funding page is generated on a web server and a link to the funding page is provided for distribution to acquaintances. Acquaintances supporting the loan via the link responsive and provide identification including their relationship. Upon achieving funding for the amount of the loan, a payment system external to the lending management system is caused to create an electronic wallet for receiving funding from the lenders for provision to the user.

### CROSS-REFERENCE TO RELATED APPLICATION

This application claims priority to GB Patent Application No. 2100153.2 filed Jan. 6, 2021, the contents of which are incorporated by reference in its entirety as if set forth herein.

### FIELD OF THE INVENTION

The present invention relates to a computer implemented lending management system and method that is particularly applicable for use in extending accessibility of lending.

### BACKGROUND TO THE INVENTION

Until very recently, organised lending of monies to individuals was something that typically was only done by banks and similar institutions. Peer-to-peer lending systems (a computer-implemented extension of cooperative banks) have had increased prominence in the past few years and offer individuals the opportunity to be lenders and also for others to source lending where they may not be able to obtain lending from a bank (or willing to accept the terms offered).

Many different regulations and requirements now govern the lending process and steps a lender must perform when taking on or handling a customer. Many of these also apply (or have been adopted) by peer-to-peer lending systems.

The overhead in setting up a new bank or lending organisation is significant and happens rarely. As a result, while there is some competition in the market in terms of products and rates available, it is limited and the only disruption to the marketplace is coming from peer-to-peer lending.

The general lending process starts with checks on an applicant, typically including verification of identity. Checks on an applicant's credit worthiness and ability to repay a loan are also generally made, often with reference to external credit rating databases. If an applicant meets a bank's lending criteria, he or she would be offered a loan, sign a contract and the funds made available. Repayments would typically be set up for a monthly direct debit or similar from the applicant's bank account to the lender.

In the case of peer-to-peer lending systems, the main difference is that at some point (typically between credit checks and offer of the loan), the loan request details are circulated to the peers enabling them to decide whether to fund the loan (whether individually or join as part of a collective).

Lending systems have become more automated and as a result have increased in terms of inflexibility. The combination of regulation and automation has meant that certain sections of users are prevented from obtaining loans.

### STATEMENT OF INVENTION

According to an aspect of the present invention, there is provided a computer implemented lending management system comprising:

an interface to an external payment system;

a data repository configured to store data on an agreed loan agreement between a user and one or more peer-to-peer lenders, the data on the agreed loan agreement including a link to a record in the external payment system corresponding to the agreed loan agreement, wherein the external payment system is configured to receive scheduled repayments from the user in respect of the loan agreement;

the lending management system further including:

a first user interface accessible by a computing device of the user and configured to receive inputs from the user via the computing device on a request to vary the agreed loan agreement;

a second user interface accessible by a computing device of one of the one or more peer-to-peer lenders and configured to receive inputs from the lender via the lender's computing device on a decision on the request;

a processor configured to execute computer program instructions to provide a repayment control system including:

computer program instructions to receive the request via the first user interface to vary the loan agreement;

computer program instructions to communicate data on the request via the second user interface to the lender;

computer program instructions to receive the decision on the request via the second user interface; and,

computer program instructions configured, upon the decision accepting the request to vary the loan agreement, to retrieve the link to a record in the external payment system from the data repository and, using the link, communicate with the external payment system to vary the scheduled repayments in dependence on the variation to the loan agreement.

According to another aspect of the present invention, there is provided a computer implemented lending management system comprising:

a first user interface accessible by a computing device of a user and configured to receive inputs from the user via the computing device on parameters for a loan being sought;

a data repository configured to store data on the user and on the parameters;

a processor configured to execute computer program instructions to generate a funding page on a web server, the funding page being associated with the user and the loan being sought, the processor being further configured to provide a link to the funding page to the user for distribution to acquaintances;

wherein upon accessing the link by a computing device of an acquaintance, the processor being configured to receive inputs from the acquaintance via the computing device on an amount of the loan to be funded and on the relationship of the acquaintance to the user, the processor being responsive to record the received inputs in the data repository and to update the funding page to show the amount of funds needed for the loan and to identify a lender as supporting the loan, the identification including the relationship, wherein upon achieving funding for the amount of the loan the processor being configured to cause a payment system external to the lending management system to create an electronic wallet for receiving funding from the lenders for provision to the user.

Embodiments of the present invention seek to provide a lending management system that seeks to provide flexibility and in particular to enable dynamic management of lending within the confines of existing regulations and systems. Furthermore, embodiments of the present invention seek to provide a lending management system in which non-standard factors and evidence as to reliability of the lendee can be applied that standard systems cannot accommodate. While the two embodiments set out below are described separately, it will be appreciated that they may be combined either in their entirety or in part or may be interfaced together.

By establishing funding with respect to relationships, embodiments of the present invention enable a degree of trust to be inferred from the funding page. For example, if it can be seen by a prospective lender that a parent or other close relation has already pledged to lend to the user, the prospective lender (who may not know the user as well) may be encouraged to support the loan. Embodiments of the present invention preferably generate a graph representing relations and acquaintances of a lendee and their inter-relationship. The graph preferably records a measure of reliability and/or trust of the lendee by the relations and acquaintances and is assessable by a computer-implemented system to calculate a score as to the overall reliability of the lendee and/or reliability with respect to a particular lender. The graph can encode relationships/trust between different lenders and/or the ethos/risk profile to which they apply to lending and provide lenders with a score or rating for the lendee with respect to that lender's ethos/risk profile. In this manner, the system enables a potential lender who does not directly know someone else seeking lending to obtain scoring/ratings from other relations or acquaintances of the lendee and from those automatically calculate a rating for the lender based on the data provided by others in the graph.

### BRIEF DESCRIPTION OF THE DRAWINGS

Embodiments of the present invention will now be described by way of example only with reference to the accompanying drawings, in which:

FIG. 1 is a schematic diagram of a computer implemented lending management system according to an embodiment;

FIG. 2 is a schematic diagram illustrating aspects of operation of the system of FIG. 1;

FIG. 3 is a schematic diagram of a computer implemented lending management system according to another embodiment; and,

FIG. 4 is a schematic diagram illustrating aspects of operation of the system of FIG. 3.

### DETAILED DESCRIPTION

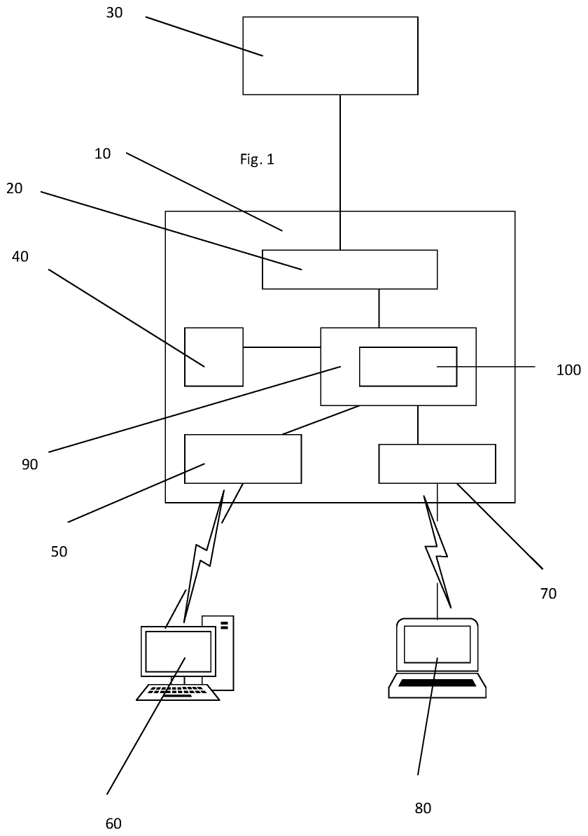

FIG. 1 is a schematic diagram of a computer implemented lending management system 10. The system comprises an interface 20 to an external payment system 30 and a data repository 40 configured to store data on an agreed loan agreement between a user and one or more peer-to-peer lenders, the data on the agreed loan agreement including a link to a record in the external payment system 30 corresponding to the agreed loan agreement, wherein the external payment system is configured to receive scheduled repayments from the user in respect of the loan agreement.

The lending management system further includes a first user interface 50 accessible by a computing device 60 of the user and configured to receive inputs from the user via the computing device on a request to vary the agreed loan agreement, a second user interface 70 accessible by a computing device 80 of one of the one or more peer-to-peer lenders and configured to receive inputs from the lender via the lender's computing device 80 on a decision on the request.

The lending management system 10 further includes a processor 90 configured to execute computer program instructions to provide a repayment control system 100. The repayment control system 100 is connected to the first 50 and second 70 user interfaces and operates as an intermediate between the user (lendee), the second user (peer-to-peer lender) and the external payment system. Should the user need to vary the loan agreement, he or she can request this via the repayment control system 100 via the user interface 50. The repayment control system 100 is responsive to contact the second user via the second user interface 70 to seek authorisation. Upon receiving authorisation, the repayment control system 100 is configured to to retrieve the link to a record in the external payment system from the data repository and, using the link, communicate with the external payment system to vary the scheduled repayments in dependence on the variation to the loan agreement.

Embodiments of the present invention enable a lendee and lender to vary terms, amounts, timing of repayments of a loan on a mutually agreed but ad-hoc basis and provides flexibility not present in current systems.

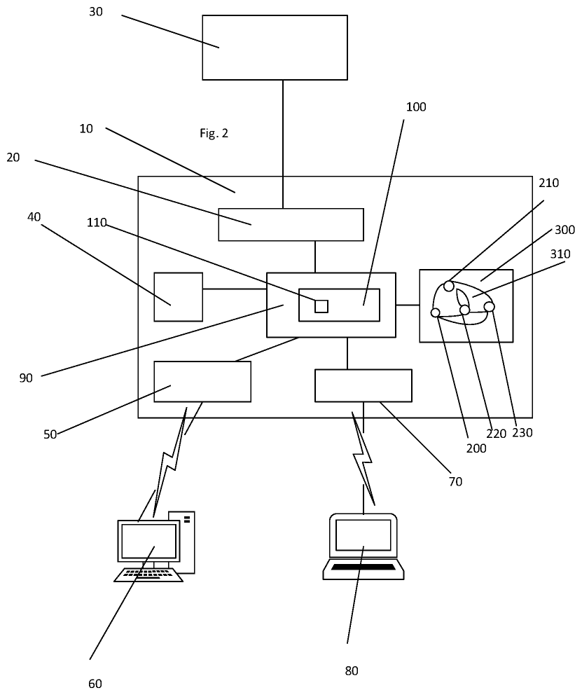

FIG. 2 is a schematic diagram illustrating aspects of operation of the system of FIG. 1.

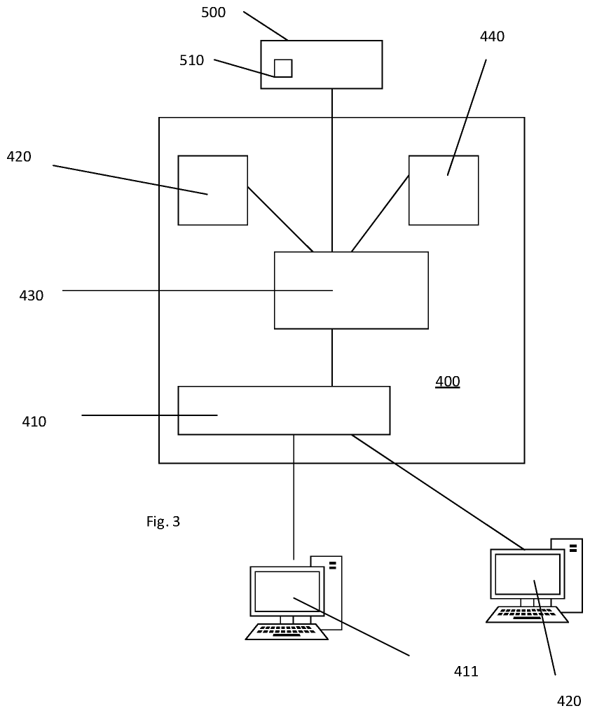

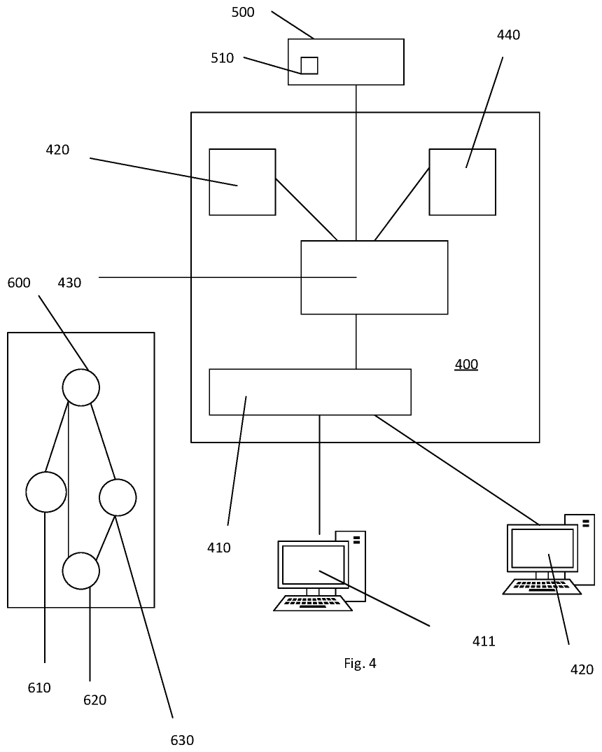

A lendee and one or more lenders agree a loan. This may be through the system described below with reference FIGS. 3 and 4 or may be in some other way. Data on the loan is provided to the repayment control system 100 either by the lender(s) and lendee or by the system/party setting up the loan. The repayment control system 100 establishes a link to a record in the external payment system 30 corresponding to the agreed loan agreement. The external payment system 30 is responsible for handling of monies, security, fraud protection and the like. It is also responsible for monitoring for timely repayment of the loan based on the agreement.

Preferably, repayment control system 100 is configured to monitor the external payment system 30 for timely payments by the lendee. should the lendee default on a repayment such as by missing a payment or making insufficient payment, the repayment control system 100 includes a record 110 for the loan agreement including preferences on how to address a default. Preferably, the record 110 is agreed as part of the loan agreement and/or is a default record and encodes a decision tree associated with the loan and events associated with the loan. Preferably the decision tree includes a link to the respective parties to be contacted in respect of each event, the outcome to be achieved and also conditions on how to escalate should the outcome not be achieved.

For example, the decision tree may specify that in the event of a repayment being over 1 day late, the lendee is to be contacted via the first user interface 50. Should the late payment not be made within 24 hours, the decision tree may specify further parties to be contacted such as a guarantor or other party linked to the lendee and/or the lenders. Should the lendee wish to vary the conditions of the loan (seek a late or missed payment for example), he or she can do so via the user interface 50 and the decision tree preferably includes data defining which lender to contact and optionally whether to automatically accept/reject certain variations.

A schematic diagram of an example decision tree is shown. In this example, the loan has been pre-agreed that payments may be up to 1 day late without requiring permission (state 200) and any further extension of time must be sought from lendees (state 210). Should a payment be late and no extension sought, the lendee is to be contacted (state 220) and if not resolved within 1 day the specified guarantor and lenders are to be contacted. Further automated action may be specified in the decision tree (further monitoring, change in loan terms, contacting further parties, etc) or alternatively may be left to intervention of the guarantor and lenders.

The decision tree is executed as a state machine 300 by the repayment control system 100. Should it be identified from the external payment system that payment is late or should the repayment control system 100 be contacted by the lendee via the user interface 50, the repayment control system retrieves the decision tree from the data repository 40 and configures a state machine 300 in memory 310 to execute the decision tree. The state machine 300 is preferably executed perpetually until such time as it reaches a state where the situation is deemed resolved (state 230) at which time the state machine 300 is stopped and unloaded from the memory 310. It will be appreciated that the state machine 300 is only executed during exceptional circumstances and each state machine can be configured specifically and uniquely for the loan agreement. This arrangement enables custom monitoring and action while limiting the amount of resources needed.

Where variations are agreed, these are preferably recorded at the repayment control system 100 and also used to update the external payment system 30 and optionally the decision tree depending on the variation agreed.

FIG. 3 is a schematic diagram of a computer implemented lending management system according to another embodiment.

In this embodiment, the computer implemented lending management system 400 comprises a first user interface 410 accessible by a computing device 411 of a user and configured to receive inputs from the user via the computing device 411 on parameters for a loan being sought, a data repository 420 configured to store data on the user and on the parameters and a processor 430 configured to execute computer program instructions to generate a funding page on a web server 440, the funding page being associated with the user and the loan being sought, the processor 430 being further configured to provide a link to the funding page to the user for distribution to acquaintances.

Upon accessing the link by a computing device 450 of an acquaintance, the processor 430 is configured to receive inputs from the acquaintance via the computing device on an amount of the loan to be funded and on the relationship of the acquaintance to the user, the processor 430 being responsive to record the received inputs in the data repository 420 and to update the funding page to show the amount of funds needed for the loan and to identify a lender as supporting the loan, the identification including the relationship. Upon the user achieving funding for the amount of the loan the processor 430 being configured to cause a payment system 500 external to the lending management system 400 to create an electronic wallet 510 for receiving funding from the lenders for provision to the user.

In this embodiment, funding of loans is associated with relationships. Further lenders considering supporting the loan are able to see from the funding page who is supporting the loan and assess level of trust attributed to the lendee by his or her network. While this may be done manually, it may also be done automatically as set out below with reference to FIG. 4.

FIG. 4 is a schematic diagram illustrating aspects of operation of the system of FIG. 3 in one embodiment.

In the above described example, lenders simply stated their relationship to the lendee and it was recorded by the data repository 420. However, in a preferred embodiment this may be automatically verified with respect to one or more social networks or other data sources. In one example, the lendee specifies his or her social network account 600 when inputting parameters of the loan via the user interface 410. Each further acquaintance wishing to support the loan is also prompted for their account in the social network 610-630 and the lending management system 400 is configured to cross-reference the accounts and obtain a measure of acquaintance of the lender and lendee (length of time accounts are linked/friends etc). Other networks or metrics may also be taken into account to construct an acquaintance score for the link between the user and supporter—for example, family tree data, social security records and other data repositories.

The system 400 may also provide the lendee with the option to select contacts to be contacted for supporting the loan in dependence on the acquaintance score—for example, irregular contacts or new “friends” may be suppressed as they would have a lower acquaintance score than good friends, close family etc.

It will be appreciated that the data repositories may take various forms including a central or distributed file store, database (such as SQL or other relational or non-relational database types). It may be implemented using storage devices such as hard disks, random access memories, solid state disks or any other forms of storage media. It will also be appreciated that the processor discussed herein may represent a single processor or a collection of processors acting in a synchronised, semi-synchronised or asynchronous manner.

It is to be appreciated that certain embodiments of the invention as discussed below may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the present invention which is defined by the recitations in the claims below and equivalents thereof.

1. A computer implemented lending management system comprising:
a first user interface accessible by a computing device of a user and configured to receive inputs from the user via the computing device on parameters for a loan being sought;
a data repository configured to store data on the user and on the parameters; and
a processor configured to execute computer program instructions to generate a funding page on a web server, the funding page being associated with the user and the loan being sought, the processor being further configured to provide a link to the funding page to the user for distribution to acquaintances,
wherein upon accessing the link by a computing device of an acquaintance, the processor being configured to receive inputs from the acquaintance via the computing device on an amount of the loan to be funded and on the relationship of the acquaintance to the user, the processor being responsive to record the received inputs in the data repository and to update the funding page to show the amount of funds needed for the loan and to identify a lender as supporting the loan, the identification including the relationship, wherein upon achieving funding for the amount of the loan the processor being configured to cause a payment system external to the lending management system to create an electronic wallet for receiving funding from the lenders for provision to the user.

2. The computer implemented lending management system of claim 1, wherein the processor is further configured to execute computer program instructions to generate a graph representing relations and acquaintances of a lendee and their inter-relationship.

3. The computer implemented lending management system of claim 2, wherein the processor is further configured to execute computer program instructions to receive and record, in the graph, a measure of reliability or trust of the lendee by the relations and acquaintances.

4. The computer implemented lending management system of claim 3, wherein the processor is further configured to execute computer program instructions to calculate a score as to the overall reliability of the lendee from said measures of reliability or trust recorded in the graph.

5. The computer implemented lending management system of claim 1, wherein the processor is further configured to execute computer program instructions to access, via a computer network, a data source to verify the relationship of the acquaintance to the user.

6. The computer implemented lending management system of claim 5, wherein the data source comprises an online social network, the processor being further configured to execute computer program instructions to receive data on the user's social network account and the acquaintance's social network account and is configured to cross-reference the social network accounts and determine a measure of acquaintance of the lender and lendee.

7. The computer implemented lending management system of claim 1, wherein the processor is further configured to execute computer program instructions to determine the measure by determining a length of time the social network accounts were linked.

8. The computer implemented lending management system of claim 6, wherein the processor is further configured to execute computer program instructions to receive, from the user via a user interface, an acquaintance threshold, the processor being further configured to execute computer program instructions to generate an acquaintance score for contacts linked to the user's social network account and to contact, as an acquaintance, the contacts having an acquaintance score greater than or equal to the threshold.

9. The computer implemented lending management system of claim 1, further comprising:
an interface to the external payment system; and
a data repository configured to store data on an agreed loan agreement between the user and one or more of the acquaintances, the data on the agreed loan agreement including a link to a record in the external payment system corresponding to the agreed loan agreement, wherein the external payment system is configured to receive scheduled repayments from the user in respect of the loan agreement;
the lending management system further including:
a first user interface accessible by a computing device of the user and configured to receive inputs from the user via the computing device on a request to vary the agreed loan agreement;
a second user interface accessible by a computing device of one of the one or more acquaintances and configured to receive inputs from the acquaintance via the acquaintance's computing device on a decision on the request;
a processor configured to execute computer program instructions to provide a repayment control system including:
computer program instructions to receive the request via the first user interface to vary the loan agreement;
computer program instructions to communicate data on the request via the second user interface to the acquaintance;
computer program instructions to receive the decision on the request via the second user interface; and
computer program instructions configured, upon the decision accepting the request to vary the loan agreement, to retrieve the link to a record in the external payment system from the data repository and, using the link, communicate with the external payment system to vary the scheduled repayments in dependence on the variation to the loan agreement.

10. The computer implemented lending management system of claim 9, wherein the processor is further configured to execute computer program instructions to monitor the external payment system for timely repayments by the user.

11. The computer implemented lending management system of claim 10, wherein the processor is further configured to execute computer program instructions to trigger execution of a predefined decision tree upon determining default on a repayment.

12. The computer implemented lending management system of claim 10, further comprising a data repository storing the decision tree, the decision tree further defining events associated with the loan to be checked, the outcome to be achieved upon an event being identified and data on escalation should the outcome not be achieved, the decision tree further including a link to the respective parties to be contacted in respect of an event identified in the decision tree.

13. The computer implemented lending management system of claim 12, wherein the processor is further configured to execute computer program instructions to execute the decision tree is executed as a state machine.

14. The computer implemented lending management system of claim 12, wherein the processor is further configured to execute computer program instructions to perpetually execute the state machine until such time as the decision tree reaches a state where the loan default is deemed resolved and to stop and unload the state machine upon the loan default being resolved.

15. A computer implemented lending management system comprising:
an interface to an external payment system; and
a data repository configured to store data on an agreed loan agreement between a user and one or more peer-to-peer lenders, the data on the agreed loan agreement including a link to a record in the external payment system corresponding to the agreed loan agreement, wherein the external payment system is configured to receive scheduled repayments from the user in respect of the loan agreement;
the lending management system further including:
a first user interface accessible by a computing device of the user and configured to receive inputs from the user via the computing device on a request to vary the agreed loan agreement;
a second user interface accessible by a computing device of one of the one or more peer-to-peer lenders and configured to receive inputs from the lender via the lender's computing device on a decision on the request; and
a processor configured to execute computer program instructions to provide a repayment control system including:
computer program instructions to receive the request via the first user interface to vary the loan agreement;
computer program instructions to communicate data on the request via the second user interface to the lender;
computer program instructions to receive the decision on the request via the second user interface; and
computer program instructions configured, upon the decision accepting the request to vary the loan agreement, to retrieve the link to a record in the external payment system from the data repository and, using the link, communicate with the external payment system to vary the scheduled repayments in dependence on the variation to the loan agreement.

16. A computer implemented lending management method comprising:
receiving, via a first user interface accessible by a computing device of a user, inputs from the user via the computing device on parameters for a loan being sought;
storing, in a data repository, data on the user and on the parameters;
generating a funding page on a web server, the funding page being associated with the user and the loan being sought;
providing a link to the funding page to the user for distribution to acquaintances;
upon the link being accessed by a computing device of an acquaintance, receiving inputs from the acquaintance via the computing device on an amount of the loan to be funded and on the relationship of the acquaintance to the user;
recording the received inputs in the data repository;
updating the funding page to show the amount of funds needed for the loan; and
identifying the acquaintance as a lender supporting the loan, the identification including the relationship,
wherein upon achieving funding for the amount of the loan the method including causing a payment system external to the lending management system to create an electronic wallet for receiving funding from the lenders for provision to the user.
